(19) United States
(12) Patent Application Publication
(10) Pub. No.: US 2025/0295123 A1
(43) Pub. Date: Sep. 25, 2025

(54) Arthropod Control Compositions

(71) Applicant: FIRMENICH SA, Satigny (CH)

(72) Inventors: Eduardo HATANO, Satigny (CH); Vincent HARRACA, Satigny (CH); Gary MARR, Monmouth Junction, NJ (US); Vincent SCHALLER, Satigny (CH)

(21) Appl. No.: 18/838,149

(22) PCT Filed: Dec. 19, 2022
(86) PCT No.: PCT/EP2022/086734

§ 371 Date: Aug. 13, 2024

Related U.S. Application Data
(60) Provisional application No. 63/292,625, filed on Dec. 22, 2021.

(30) Foreign Application Priority Data
Jan. 5, 2022 (EP) 22150276.8

(51) Int. Cl. A01N 65/28; A01M 29/12; A01N 25/18; A01N 31/02; A01N 35/02; A01N 65/22; A01N 65/24; A01N 65/36; A01P 17/00

(52) U.S. Cl. CPC A01N 65/28; A01M 29/12; A01N 25/18; A01N 31/02; A01N 35/02; A01N 65/22; A01N 65/24; A01N 65/36; A01P 17/00

(57) ABSTRACT

The present invention relates to an arthropod control compositions, methods and uses to control arthropods as well as arthropod control articles comprising the same.

### TECHNICAL FIELD

The present invention relates to an arthropod control compositions, methods and uses to control arthropods as well as arthropod controlling articles comprising the same.

### BACKGROUND

Many mammals, including humans, are suffering from the action of arthropods. Some arthropods, such as for example mosquitoes and ticks, are not desirable for vertebrates such as mammals and in particular human subjects as they bite and, consequently, cause itching, transmission of diseases and/or germs or may be the cause for other diseases and/or conditions. Similarly, other pests indirectly affect human activity or society by eating, parasitizing, or destroying plant materials that are used as food, feed or raw materials. Still further pests are involved in the destruction or weakening of furniture or structures used or built by humans. These damages may directly be attributed to the arthropods or by their capability of spreading germs causing such issues.

Arthropod control compositions include active substances and when applied to skin, clothing, or other surfaces, they may discourage arthropods from landing or climbing on that surface. Arthropod control agents help preventing and controlling the outbreak of arthropod-borne diseases, such as malaria, etc.

Some of the known arthropod controlling agents and composition, however, have certain drawbacks as they can have negative effects, i.e. negative olfactive properties, such as no or bad smell, or in turn only weak arthropod controlling, in particular arthropod repelling properties.

There is a need to provide arthropod control compositions that have both good olfactive properties, i.e. a good hedonic effect, and good arthropod controlling, in particular arthropod repelling properties.

The prior art does not disclose or suggest the arthropod control compositions according to the present invention.

### DETAILED DESCRIPTION

The present invention provides arthropod, preferably insect, control composition comprising one or more of the following combinations of substances:
(a) clove oil, 2-(4-methylcyclohex-3-en-1-yl)propan-2-ol, orange oil, 3,7-dimethylocta-2,6-dien-1-ol and mint oil;
(b) 3,7-dimethylnona-1,6-dien-3-ol, 5-pentyloxolan-2-one, 3-methyl-5-phenyl-1-pentanol, lavandin oil, clove oil, 3,7-dimethylocta-2,6-dien-1-ol and orange oil;
(c) 5-pentyloxolan-2-one, 1,2,2-trimethyl-13-oxabicyclo[10.1.0]trideca-4,8-diene and 5-hexyloxolan-2-one.

To the best knowledge of the inventors the composition of the first aspect of the invention has not previously been disclosed or speculated as having arthropod control properties. Moreover the composition as claimed herein has both arthropod control properties and desirable hedonic profile and therefore combines both perfuming and arthropod controlling properties in a single composition.

An embodiment of the invention is wherein combination (a) comprises: 5-40%, preferably 20-35% clove oil, 5-35%, preferably 15-30% 2-(4-methylcyclohex-3-en-1-yl)propan-2-01, 4-40%, preferably 20-35% orange oil, 2-20%, preferably 5-15% 3,7-dimethylocta-2,6-dien-1-ol, and 2-70%, preferably 5-50% mint oil.

A further embodiment of the invention is wherein combination (a) further comprises 0.01 to 20%, preferably 0.01 to 10% thyme oil.

A further embodiment of the invention is wherein combination (a) comprises 5% clove oil, 7% 2-(4-methylcyclohex-3-en-1-yl)propan-2-ol, 4% orange oil, 3% 3,7-dimethylocta-2,6-dien-1-ol, 15% mint oil and 0.1% thyme oil. This composition is designated A1 in the accompanying examples.

A further embodiment of the invention is wherein combination (a) comprises 5% clove oil, 7% 2-(4-methylcyclohex-3-en-1-yl)propan-2-ol, 4% orange oil, 3% 3,7-dimethylocta-2,6-dien-1-ol, 15% mint oil and 0.2% thyme oil. This composition is designated A2 in the accompanying examples.

A further embodiment of the invention is wherein combination (a) comprises 15% clove oil, 19% 2-(4-methylcyclohex-3-en-1-yl)propan-2-ol, 10% orange oil, 8% 3,7-dimethylocta-2,6-dien-1-ol, 43% mint oil and 0.3% thyme oil. This composition is designated A3 in the accompanying examples.

A further embodiment of the invention is wherein combination (a) comprises 12% clove oil, 16% 2-(4-methylcyclohex-3-en-1-yl)propan-2-ol, 8% orange oil, 7% 3,7-dimethylocta-2,6-dien-1-ol, 35% mint oil and 0.5% thyme oil. This composition is designated A4 in the accompanying examples.

A further embodiment of the invention is wherein combination (a) comprises 31% clove oil, 15% 2-(4-methylcyclohex-3-en-1-yl)propan-2-ol, 30% orange oil, 10% 3,7-dimethylocta-2,6-dien-1-ol, 10% mint oil and 1% thyme oil. This composition is designated A5 in the accompanying examples.

A further embodiment of the invention is wherein combination (a) comprises 28% clove oil, 24% 2-(4-methylcyclohex-3-en-1-yl)propan-2-ol, 30% orange oil, 7% 3,7-dimethylocta-2,6-dien-1-ol and 8% mint oil. This composition is designated A6 in the accompanying examples.

A further embodiment of the invention is wherein combination (b) comprises: 5-35%, preferably 10-35% 3,7-dimethylnona-1,6-dien-3-ol, 2-20%, preferably 5-15% 5-pentyloxolan-2-one, 2-20%, preferably 2-10% 3-methyl-5-phenyl-1-pentanol, 2-20%, preferably 5-15% lavandin oil, 1-20%, preferably 2-10% clove oil, 1-15%, preferably 1-10% 3,7-dimethylocta-2,6-dien-1-ol and 1-15%, preferably 2-10% orange oil.

A further embodiment of the invention is wherein combination (b) further comprises 0.5-10%, preferably 1-5% chromen-2-one, 0.5-10%, preferably 1-5% 3,7-dimethylocta-2,6-diena, 0.5-10%, preferably 1-5% 4-hydroxy-3-methoxybenzaldehyde and 0.01-10%, preferably 0.01-5% cinnamon oil.

A further embodiment of the invention is wherein combination (b) comprises 10% 3,7-dimethylnona-1,6-dien-3-ol, 5% 5-pentyloxolan-2-one, 4% 3-methyl-5-phenyl-1-pentanol, 5% lavandin oil, 3% clove oil, 3% 3,7-dimethylocta-2,6-dien-1-ol, 3% orange oil, 1% chromen-2-one, 1% 3,7-dimethylocta-2,6-dienal, 1% 4-hydroxy-3-methoxybenzaldehyde and 0.1% cinnamon oil. This composition is designated B1 in the accompanying examples.

A further embodiment of the invention is wherein combination (b) comprises 21% 3,7-dimethylnona-1,6-dien-3-ol, 10% 5-pentyloxolan-2-one, 8% 3-methyl-5-phenyl-1-pentanol, 10% lavandin oil, 6% clove oil, 6% 3,7-dimethylocta-2,6-dien-1-ol, 6% orange oil, 2% chromen-2-one, 2% 3,7-dimethylocta-2,6-dienal, 2% 4-hydroxy-3-methoxybenzaldehyde and 0.2% cinnamon oil. This composition is designated B2 in the accompanying examples.

A further embodiment of the invention is wherein combination (b) comprises 20% 3,7-dimethylnona-1,6-dien-3-ol, 10% 5-pentyloxolan-2-one, 8% 3-methyl-5-phenyl-1-pentanol, 10% lavandin oil, 6% clove oil, 6% 3,7-dimethylocta-2,6-dien-1-ol, 6% orange oil, 2% chromen-2-one, 2% 3,7-dimethylocta-2,6-dienal, 2% 4-hydroxy-3-methoxybenzaldehyde and 0.2% cinnamon oil. This composition is designated B3 in the accompanying examples.

A further embodiment of the invention is wherein combination (b) comprises 20% 3,7-dimethylnona-1,6-dien-3-ol, 10% 5-pentyloxolan-2-one, 8% 3-methyl-5-phenyl-1-pentanol, 10% lavandin oil, 6% clove oil, 6% 3,7-dimethylocta-2,6-dien-1-ol, 4% orange oil, 2% chromen-2-one, 2% 3,7-dimethylocta-2,6-dienal, 2% 4-hydroxy-3-methoxybenzaldehyde and 0.1% cinnamon oil. This composition is designated B4 in the accompanying examples.

A further embodiment of the invention is wherein combination (c) comprises: 20-90%, preferably 40-80% 5-pentyloxolan-2-one, 2-15%, preferably 4-10% 1,2,2-trimethyl-13-oxabicyclo[10.1.0]trideca-4,8-diene, 2-15%, preferably 4-10% 5-hexyloxolan-2-one.

A further embodiment of the invention is wherein combination (c) further comprises 0.5-10%, preferably 1-5% 5-hexyloxolan-2-one, 0.5-10%, preferably 1-5% 6-pentyloxan-2-one, 0.01-10%, preferably 0.01-5% 5-butyloxolan-2-one, 0.01-10%, preferably 0.01-5% lemongrass oil, 0.01-10%, preferably 0.01-5% citronella oil, 0.01-5%, preferably 0.01-2% 3,7-dimethyloct-6-enal, 0.01-5%, preferably 0.01-2% 3,7-dimethylocta-2,6-dienal.

A further embodiment of the invention is wherein combination (c) comprises 43% 5-pentyloxolan-2-one, 4% 1,2,2-trimethyl-13-oxabicyclo[10.1.0]trideca-4,8-diene, 4% 5-hexyloxolan-2-one, 2% 6-pentyloxan-2-one, 2% 5-butyloxolan-2-one and 1% lemongrass oil. This composition is designated C1 in the accompanying examples.

A further embodiment of the invention is wherein combination (c) comprises 41% 5-pentyloxolan-2-one, 5% 1,2,2-trimethyl-13-oxabicyclo[10.1.0]trideca-4,8-diene, 4% 5-hexyloxolan-2-one, 2% 6-pentyloxan-2-one, 2% 5-butyloxolan-2-one, 1% lemongrass oil and 0.21% 3,7-dimethyloct-6-enal. This composition is designated C2 in the accompanying examples.

A further embodiment of the invention is wherein combination (c) comprises 72% 5-pentyloxolan-2-one, 8% 1,2,2-trimethyl-13-oxabicyclo[10.1.0]trideca-4,8-diene, 7% 5-hexyloxolan-2-one, 4% 6-pentyloxan-2-one, 4% 5-butyloxolan-2-one, 1% lemongrass oil, 0.25% citronella oil and 0.37% 3,7-dimethyloct-6-enal. This composition is designated C3 in the accompanying examples.

A further embodiment of the invention is wherein combination (c) comprises 72% 5-pentyloxolan-2-one, 8% 1,2,2-trimethyl-13-oxabicyclo[10.1.0]trideca-4,8-diene, 8% 5-hexyloxolan-2-one, 4% 6-pentyloxan-2-one, 4% 5-butyloxolan-2-one, 1% lemongrass oil, 0.37% 3,7-dimethyloct-6-enal, 0.12% 3,7-dimethylocta-2,6-dienal. This composition is designated C4 in the accompanying examples.

A further embodiment of the invention is wherein combination (c) comprises 43% 5-pentyloxolan-2-one, 5% 1,2,2-trimethyl-13-oxabicyclo[10.1.0]trideca-4,8-diene, 4% 5-hexyloxolan-2-one, 2% 6-pentyloxan-2-one and 2% 5-butyloxolan-2-one oil and 0.2% lemongrass oil.

It can be appreciated that each of the embodiments of the invention as provided herein may not comprise 100% of the composition of the invention. In such circumstances additional components can be used, for example to further improve the hedonic profile or adapt the hedonic profile for specific application by the consumer of the composition, solvents to aid the delivery of the composition of the invention, stabilizers and preservatives to improve the integrity and conservation of the composition as may be needed for anticipated use by the consumer. Further components include additional arthropod control co-ingredients as provided below.

The components used in the composition of the invention are known in the art and can be readily synthesized or obtained. The following list provides the CAS number for each of the components. 2-(4-methylcyclohex-3-en-1-yl)propan-2-ol (CAS number 98-55-5), 3,7-dimethylocta-2,6-dien-1-ol (CAS number 106-24-1), Thyme oil (CAS number 8007-46-3), 3,7-dimethylnona-1,6-dien-3-ol (CAS number 8007-46-3), 5-pentyloxolan-2-one (CAS number 104-61-0), 3-methyl-5-phenyl-1-pentanol (CAS number 55066-48-3), Lavandin oil (CAS number 8022-15-9), clove oil (CAS number 8000-34-8),chromen-2-one (CAS number 91-64-5), 3,7-dimethylocta-2,6-dienal (CAS number 5392-40-5), 4-hydroxy-3-methoxybenzaldehyde (CAS number 121-33-5), 1,2,2-trimethyl-13-oxabicyclo[10.1.0]trideca-4,8-diene (CAS number 71735-79-0), 5-hexyloxolan-2-one (CAS number 706-14-9), 6-pentyloxan-2-one (CAS number 705-86-2), 5-butyloxolan-2-one (CAS number 104-50-7), lemongrass oil (CAS number 8007-02-1), citronella oil (CAS number 8000-29-1), 3,7-dimethyloct-6-enal (CAS number 106-23-0), 3,7-dimethylocta-2,6-dienal (CAS number 5392-40-5)

By “mint oil” we include the mint oil defined in CAS number 8006-90-4, 68917-18-0 and 8008-79-5, and mixtures of the mint oils as defined by those CAS numbers.

By “orange oil” we include the orange oil defined in CAS number 8007-80-5, 8016-38-4, 68647-72-3, 68514-75-0, 68606-94-0 and 68916-04-1, and mixtures of the orange oils as defined by those CAS numbers.

By “cinnamon oil” we include the cinnamon oil defined in CAS number 8007-80-5 and 8015-91-6, and mixtures of the cinnamon oils as defined by those CAS numbers.

In a preferred embodiment of the invention the arthropod control composition has a good hedonic profile.

The present inventors have good appreciated that it may be desirable for arthropod control compositions to have an acceptable hedonic profile. This is because the compositions may be used in close proximity to a consumer and, as can be understood, any unpleasant hedonic profile may inhibit the use of the composition.

The term “arthropod” has the normal meaning for a skilled person in the technical field. Arthropods include invertebrate animals, such as insects, arachnids, and crustaceans, that have a segmented body and jointed appendages. Arthropods usually have a chitinous exoskeleton molted at intervals, and a dorsal anterior brain connected to a ventral chain of ganglia.

Arthropods in the present invention's understanding relate to undesired arthropods, meaning that their presence in the air, on the surface of an article, the surface of a plant or the surface of a vertebrate, such as a human subject or other mammal, preferably human subject, is not desired. Preferably undesired arthropods are pest arthropods that impact plants and animals, e.g. thrips, aphids, beetles, moth, mealybug, scale etc., more preferably pest arthropods that impact animals, e.g. ants, termites, cockroaches, flies, etc., even more preferably blood feeding arthropods that impact vertebrates, e.g. biting fly, bed bug, kissing bug, flea, lice, mosquitos and ticks, even more preferably mosquitos and ticks.

The reason why the presence of an arthropod is not desired might be that the arthropod's presence in the air is unpleasant to a subject, the contact of an arthropod on an article transfers diseases and/or germs or the arthropod bites an organism and causes itching, the transmission of diseases and/or germs or the arthropod feeding may be the cause for other diseases and/or conditions.

In a particular embodiment, the arthropod is an insect or an arachnid, preferably an insect.

The term “insect” has the normal understanding by a skilled person the technical field. An insect is described by a well-defined head, thorax, and abdomen, only three pairs of legs, and typically one or two pairs of wings

In a particular embodiment, the insect is a mosquito, biting fly, bedbug, kissing bug, flea, lice, ant, termite, cockroach, fly, aphid, beetle, thrips, moth, mealybug or scale bug, more preferably a mosquito.

The term “arachnid” has the normal understanding by a skilled person the technical field. An arachnid is described having a segmented body divided into two regions of which the anterior bears four pairs of legs but no antennae

In a particular embodiment, the arachnid is a tick, mite, chigger or spider, more preferably a tick.

The expression “control”, “arthropod control”, “insect control” or “arachnid control” or the like has the normal meaning for a skilled person in the technical field.

“Controlling” in the context of the present invention defines the ability of an arthropod controlling composition according to the present invention to attract, deter, kill or repel an arthropod, preferably deter or repel an arthropod and even more preferably repel an arthropod

“Attracting” according to the present invention defines the ability of an arthropod attractant composition according to the invention to increase or encourage contact or the presence of an arthropod at the arthropod attractant source, such as in the air, on the surface of an article or on the surface of a vertebrate, such as a human subject or other mammal, preferably an article such as a trapping device, the arthropod attractant compound or composition has been applied to.

“Repellency” according to the present invention defines the ability of an arthropod repellent composition according to the present invention to minimize, reduce, discourage or prevent approach or the presence of an arthropod at the arthropod repellent source, such as in the air, on the surface of an article or on the surface of a vertebrate, such as a human subject or other mammal, preferably human subject, to which the arthropod repellent compound or composition has been applied to.

“Deterring” according to the present invention defines the ability of an arthropod deterrent composition according to the invention to minimize, reduce, discourage or prevent contact or the presence of an arthropod at the arthropod deterrent source, such as in the air, on the surface of an article or on the surface of a vertebrate, such as a human subject or other mammal, preferably human subject, to which the arthropod deterrent compound or composition has been applied to. Typically, the deterrent effect is shown when used as feeding deterrent hindering a pest from subsequent food intake or oviposition or physical contact after an initial tasting of the arthropod deterrent compound or composition.

“Spatial Repellency” according to the present invention defines the ability of an arthropod repellent composition according to the present invention to minimize, reduce, discourage or prevent approach or the presence of an arthropod at the arthropod repellent source, such as in the air, on the surface of an article or on the surface of an vertebrate, such as a human subject or other mammal, preferably human subject, to which the arthropod repellent compound or composition has been applied to. Typically, the spatial repellency effect is shown when spatial repellent compound or composition released, sprayed, spread or diffused in the air or liquid hinder a pest from entering the zone in which the spatial repellent compound or composition is present. Repellence occurs therefore from a distance, the pest not necessarily entering in direct contact with the treated article or organism to protect.

“Killing” according to the present invention defines the ability of arthropod killing composition according to the present invention to kill an arthropod at the arthropod killing source, such as in the air, on the surface of an article or on the surface of a vertebrate, such as a human subject or other mammal, preferably human subject, to which the arthropod killing compound or composition has been applied to. When an arthropod killing composition is applied to a plant, an animal or human subject, it is applied in an amount which is killing to the arthropod but not to the subject.

In a particular embodiment, the arthropod control composition is an arthropod repelling composition, preferably an insect repelling composition, more preferably a mosquito repelling composition.

In a particular embodiment, the arthropod controlling source is the surface and/or the air in the vicinity of an article, preferably a candle, coil, electric diffuser, wristband, patch, collar, ear tag, clothes, fabrics, papers, biochar, cardboard, cellulosic pads, bed nets, screen, curtains, furniture, walls, ground or paint, or the surface of a subject, preferably the surface of a vertebrate, such as a human subject or other mammal, preferably human subject, i.e. the skin of a human subject treated with a product such as spray, aerosol, cream, roll on, wristband, lotion, soap, shampoo, sunscreen or patch or a cloth treated with a product such as laundry powder, liquid detergent, spray, lotion, powder.

The arthropod controlling effect according to the present invention is determined on mosquitoes using an adapted Warm Body assay as defined in Kröber T, Kessler S, Frei J, Bourquin M, Guerin PM. An in vitro assay for testing mosquito controlling compounds employing a warm body and carbon dioxide as a behavioral activator. J Am Mosq Control Assoc. 2010; 26:381-386. Further information is provided in the accompanying examples

The controlling effect, repellence & spatial repellence, according to the present invention is determined by testing the Warm Body assay against the yellow fever mosquito, Aedes aegypti Rockefeller strain. A. aegypti is a model organism for controlling tests and one of the recommended model organisms by the World Health Organization (WHO) as it is a very aggressive, anthropophilic mosquito species that shows generally low sensitivity to arthropod controlling compounds. Observations of controlling efficacy were made on host-seeking females of uniform age, 5 to 10 days old selected as mentioned in the publication mentioned hereinabove. Tested hungry females had access to 10% sugar solution but were not blood-fed. Further information is provided in the accompanying examples.

The published protocol has been adapted in not manually counting the landing mosquitoes but automatically using an automatic counting software, the switch from Anopheles gambiae to A. aegypti led to a decrease of mosquitoes' number placed in the tested cage due to the size difference (i.e. 30 mosquitoes instead of 50) and to an increase of lighting as A. aegypti is a diurnal mosquitoes (i.e. 150 lux instead of 4 lux). Further information is provided in the accompanying examples.

The controlling effect, repellence & spatial repellence, according to the present invention is also determined according to an arm in the box method adapted from the WHO Guidelines for efficacy testing of mosquito repellents for human skin (WHO/CDS/NTD/WHOPES/2009.4). The readiness of 100 hungry female mosquitoes A. aegypti to a test substance is assessed by comparing the results of an untreated arm to a treated in when inserted into the cage (40×40×40 cm) for 30 seconds (negative control) three times. Further information is provided in the accompanying examples.

The activity for substances to repel arachnids such as ticks may be assessed using the protocol of the in-vitro Warm Plate Assay as defined in Kröber T, Bourquin M, Guerin PM. 2013. A standardized in vivo and in vitro test method for evaluating tick repellents. Pestic. Biochem. Phys. 107(2):160-168.

In a particular embodiment, the amount and selection of the substance is in a way that it contributes, enhances or improves both, the arthropod control activity and the hedonic character of the composition.

In one embodiment, the arthropod control composition may further comprise an arthropod control co-ingredient. By “arthropod control co-ingredient” is understood an ingredient capable of imparting additional arthropod controlling benefits to the arthropod controlling effect of the composition herein described.

In one embodiment, the substance herein described is capable to modify, enhance or improve the arthropod controlling effect of the arthropod control co-ingredient, e.g. by reducing the amount of the arthropod control co-ingredient within a composition. This can be particularly beneficial in case the arthropod control co-ingredient is harmful to human subjects at a certain dose or in case the arthropod control co-ingredient has negative olfactive properties at a certain dose.

According to a particular embodiment, the combination of the substance herein described and an arthropod control co-ingredient results in a synergistic arthropod controlling effect.

According to a particular embodiment, the combination of substance herein described and an arthropod control co-ingredient results in a modified, pleasant, enhanced or improved olfactory impression of the overall composition in comparison to its single ingredients.

According to one embodiment arthropod control co-ingredient is selected from the group consisting of: N,N-diethyl-3-methylbenzamide (DEET), ethyl butylacetylaminopropionate (IR3535); para-menthan-3,8-diol (PMD); 1-(1-methylpropoxycarbonyl)-2-(2-hydroxaethyl)piperidin (picaridin); Cedarwood oil China, Cedarwood oil Texas, Cedarwood oil Virginia, Cinnamon oil, Citronella oil, Cornmint oil, Cymbopogon winterianus oil fractionated hydrated cyclized, decanoic acid, Eucalyptus citriodora oil Eucalyptus citriodora oil hydrated cyclized, eugenol, Garlic oil, geraniol, Geranium oil, Lavender, Lavandula hybrida ext., Lavandin oil, Lemon oil, Lemongrass oil, Margosa extract, Metofluthrin, mixture of cis- and trans-p-menthane-3,8 diol, N,N-diethyl-meta-toluamide, nonanoic acid, Rosemary oil, Thyme oil, Wintergreen oil, 2,3,4,5-bis(butyl-2-ene)tetrahydrofurfural (MGK Repellent 11), cineole, cinnamaldehyde, citronellal, citronellol, coumarin, dibutyl phthalate, diethyl phthalate, dimethyl anthranilate, dimethyl phthalate, ethyl vanillin, Eucalyptus oil, delta-octalactone, delta-nonalactone, delta-decalactone, delta-undecalactone, delta-dodecalactone, gamma-octalactone, gamma-nonalactone, gamma-decalactone, gamma-undecalactone, gamma-dodecalactone, hydroxy citronellal, Lime oil, limonene, linalool, methyl anthranilate, Mint oil, myrcene, Neem oil, sabinene, β-caryophyllene, (1H-indol-2-yl)acetic acid, anethole, Anise oil, Basil oil, Bay oil, camphor, ethyl salicylate, Evergreen oils (pine oil), (1,3,4,5,6,7-hexahydro-1,3-dioxo-2H-isoindol-2-yl)methyl (1R-trans)-2,2-dimethyl-3-(2-methylprop-1-enyl)cyclopropanecarboxylate (d-Tetramethrin), (RS)-3-Allyl-2-methyl-4-oxocyclopent-2-enyl-(1R,3R; 1R,3S)-2,2-dimethyl-3-(2-methylprop-1-enyl)-cyclopropanecarboxy late (mixture of 4 isomers 1R trans, 1R:1R trans, 1S: 1R cis, 1R: 1R cis,1S 4:4:1:1) (d-Allethrin), (RS)-α-cyano-3phenoxybenzyl-(1 RS)-cis, trans-3-(2,2-dichlorovinyl)-2,2-dimethylcyclopropanecarboxylate (Cypermethrin), 2-methyl-4-oxo-3-(prop-2-ynyl)cyclopent-2-en-1-yl 2,2-dimethyl-3-(2-methylprop-1-enyl)cyclopropanecarboxylate (Prallethrin), Acetamiprid, Azadirachtin, Bendiocarb, Bifenthrin, boric acid, Chlorpyrifos, Deltamethrin, Diazinon, Dichlorvos, eugenol, Fipronil, Imidacloprid, linalool, Malathion, Maltodextrin, Metofluthrin, Nicotine, Permethrin, Pyrethrins and Pyrethroids, Rotenone, silicium dioxide (Kieselguhr), S-Methoprene, Spinosad (Spinosyn A), Spinosyn D, Tetramethrin, Transfluthrin, (E)-1-(2,6,6-trimethylcyclohex-2-en-1-yl)but-2-en-1-one, (3Z)-3-butylidene-2-benzofuran-1-one, 4-ethenyl-2-methoxyphenol, Cognac oil green, Labdanum extract (Cistus spp.), 5-pentyloxolan-2-one, chromen-2-one, (2E)-3,7-dimethylocta-2,6-dienal, 4-hydroxy-3-methoxybenzaldehyde, (5R)-2-methyl-5-prop-1-en-2-ylcyclohex-2-en-1-one, Mentha spicata oil, 6-hexyloxan-2-one, 5-methyl-2-propan-2-ylcyclohexyl] acetate, Nigella damascena oil, 2-phenylethanol, 6-pentyloxan-2-one, (4-methoxyphenyl)methyl acetate, Syzygium aromaticum oil, 3,4,4a,5,6,7,8,8a-octahydrochromen-2-one, (1S,6R)-3,7,7-trimethylbicyclo[4.1.0]hept-3-ene, 2-phenylethyl 2-methylpropanoate, methyl 2-(3-oxo-2-pent-2-enylcyclopentyl)acetate, (4R)-4-(2-methoxypropan-2-yl)-1-methylcyclohexene, Mentha piperita oil, 2-methoxy-4-[(E)-prop-1-enyl]phenol, 2-methyl-3-(4-propan-2-ylphenyl)propanal and (4-methoxyphenyl)methanol and mixtures thereof.

In a particular embodiment, the arthropod control co-ingredient is comprised in an amount of from 0.02 to 80 wt. %, more preferably in an amount of from 0.05 to 70 wt. %, even more preferably in an amount of from 0.1 to 60 wt. %, based on the total weight of the composition. Thereby, it is understood that the composition comprises the arthropod control co-ingredient in a minimum amount of at least 0.02 wt. %, at least 0.05 wt. % or at least 0.1 wt. % and a maximum amount of not more than 80 wt. %, not more than 70 wt. % or not more than 60 wt. %, based on the total weight of the composition.

In a particular embodiment, within the limitations of the amount of the substance in the composition as stated above, the substance in the composition of the invention and the arthropod control co-ingredient are comprised in the composition in a weight range of 90:10 to 10:90, preferably in a weight range of 80:20 to 20:80, more preferably in a weight range of 65:35 to 35:65 and most preferably in a weight range of 60:40 to 40:60. It is herein also understood that substance and the arthropod control co-ingredient can be comprised in the composition in any weight range combination as mentioned herein-before, such as 90:10 to 20:80, preferably 35:65 and more preferably 40:60, 80:20 to 10:90, preferably 35:65 and more preferably 40:60, 65:35 to 10:90, preferably 20:80 and more preferably 40:60 or 40:60 to 10:90, preferably 20:80 and more preferably 35:65.

In one embodiment, the arthropod control composition may further comprise perfume ingredients. Perfume ingredients are understood as contributing, modifying, enhancing or improving the olfactory character of the composition but do not contribute to, enhance or improve the arthropod controlling effect of the composition. Perfume ingredients providing such hedonic effects and suitable for use in the composition of the invention are known in the art and can be readily identified by the skilled person.

The arthropod control composition can further comprise a carrier. By “carrier” is understood a material with which the active compound is mixed or formulated to facilitate its application a locus or other object to be treated, or its storage, transport and/or handling. Said carrier may be of inorganic or organic or of synthetic natural origin. Said carrier may be a liquid or a solid.

As liquid carrier one may cite, as non-limiting examples, an emulsifying system, i.e. a solvent and a surfactant system, or a solvent commonly used in perfumery. A detailed description of the nature and type of solvents commonly cannot be exhaustive. However, one can cite as non-limiting examples, solvents such as butylene or propylene glycol, glycerol, dipropylene glycol and its monoether, 1,2,3-propanetriyl triacetate, dimethyl glutarate, dimethyl adipate 1,3-diacetyloxypropan-2-yl acetate, diethyl phthalate, isopropyl myristate, benzyl benzoate, benzyl alcohol, 2-(2-ethoxyethoxy)-1-ethanol, tri-ethyl citrate, 2-methylprop-1-ene and 2-(2-ethoxyethoxy)ethanol or mixtures thereof, particular suitable are dipropylene glycol, 2-methylprop-1-ene and 2-(2-ethoxyethoxy)ethanol and mixtures thereof.

For the compositions which comprise both a carrier, other suitable carriers than those previously specified, can be also ethanol, water/ethanol mixtures, limonene or other terpenes, isoparaffins such as those known under the trademark Isopar® (origin: Exxon Chemical) or glycol ethers and glycol ether esters such as those known under the trademark Dowanol® (origin: Dow Chemical Company) like Dowanol™ DPMA (Glycol Ether Acetate), or Augeo® Clean Multi (isopropylidene glycerol; origin: Solvay), or hydrogenated castors oils such as those known under the trademark Cremophor® RH 40 (origin: BASF).

Solid carrier is meant to designate a material to which the arthropod control composition or some element of the arthropod control composition can be chemically or physically bound. In general, such solid carriers are employed either to stabilize the composition, or to control the rate of evaporation of the compositions or of some ingredients. The use of solid carrier is of current use in the art and a person skilled in the art knows how to reach the desired effect. However, by way of non-limiting example of solid carriers, one may cite absorbing gums or polymers or inorganic material, such as porous polymers, cyclodextrins, wood based materials, organic or inorganic gels, clays, gypsum talc or zeolites.

As other non-limiting examples of solid carriers, one may cite encapsulating materials. Examples of such materials may comprise wall-forming and plasticizing materials, such as mono, di- or trisaccharides, natural or modified starches, hydrocolloids, cellulose derivatives, polyvinyl acetates, polyvinylalcohols, proteins or pectins, or other such materials. The encapsulation is a well-known process to a person skilled in the art, and may be performed, for instance, by using techniques such as spray-drying, agglomeration or yet extrusion; or consists of a coating encapsulation, including coacervation and complex coacervation technique.

As non-limiting examples of solid carriers, one may cite in particular the core-shell capsules with resins of aminoplast, polyamide, polyester, polyurea or polyurethane type or a mixture thereof (all of said resins are well known to a person skilled in the art) using techniques like phase separation process induced by polymerization, interfacial polymerization, coacervation or altogether (all of said techniques have been described in the prior art), optionally in the presence of a polymeric stabilizer or of a cationic copolymer.

Resins may be produced by the polycondensation of an aldehyde (e.g. formaldehyde, 2,2-dimethoxyethanal, glyoxal, glyoxylic acid or glycolaldehyde and mixtures thereof) with an amine such as urea, benzoguanamine, glycoluryl, melamine, methylol melamine, methylated methylol melamine, guanazole and the like, as well as mixtures thereof. Alternatively, one may use preformed resins alkylolated polyamines such as those commercially available under the trademark Urac® (origin: Cytec Technology Corp.), Cymel® (origin: Cytec Technology Corp.), Urecoll® or Luracoll® (origin: BASF).

Others resins one are the ones produced by the polycondensation of an a polyol, like glycerol, and a polyisocyanate, like a trimer of hexamethylene diisocyanate, a trimer of isophorone diisocyanate or xylylene diisocyanate or a Biuret of hexamethylene diisocyanate or a trimer of xylylene diisocyanate with trimethylolpropane (known with the tradename of Takenate®, origin: Mitsui Chemicals), among which a trimer of xylylene diisocyanate with trimethylolpropane and a Biuret of hexamethylene diisocyanate.

Many articles have been published relating to the encapsulation by polycondensation of amino resins, namely melamine-based resins with aldehydes. Such articles already describe the various parameters affecting the preparation of such core-shell microcapsules. These documents are known to the skilled person and the contents therein be used in the field of the present invention.

The present invention also relates to a method for arthropod, preferably insect, control which comprises bringing an arthropod, preferably insect, into direct contact or in contact with vapors of a composition as described hereinabove.

For the sake of clarity, the arthropod controlling composition according to the present invention can be applied to the air, to the surface of an article, the air in the vicinity of the surface of an article or the surface of a subject by usual methods known in the art such as spraying, applying, wearing or diffusing.

In a particular embodiment, the arthropod controlling composition according to the present invention is applied to the surface of an article, the air in the vicinity of the surface of an article or to the surface of an animal or subject.

In a particular embodiment, the article can be an arthropod control article as described hereinbelow and in particular, can be a candle, coil, electric diffuser, wristband, patch, collar, ear tag, clothes, fabrics, papers, biochar, cardboard, cellulosic pads, bed nets, screen, curtains, furniture, paint, walls, ground, spray, aerosol, cream, roll on, wristband, lotion, soap, shampoo, sunscreen, laundry powder, liquid detergent, spray, lotion, powder.

In a particular embodiment, the surface of a subject is the surface of a human or animal subject, preferably the surface is a human subject, i.e. the skin of a human subject.

The present invention also relates to a use of a composition as defined hereinabove to control arthropods, preferably insects.

The present invention also relates to an arthropod control article comprising the arthropod control composition as described hereinabove.

By “arthropod control article” is understood to designate a consumer product which delivers at least an arthropod controlling effect to the surface or space to which it is applied (e.g. skin, hair, textile, or home surface). In other words, an arthropod controlling article according to the invention is a consumer product which comprises a functional formulation, as well as optionally additional benefit agents, corresponding to the desired consumer product, and an arthropod controlling amount of at least one of the substances. For the sake of clarity, said consumer product is a non-edible product.

The nature and type of the constituents of the consumer product do not warrant a more detailed description here, which in any case would not be exhaustive, the skilled person being able to select them on the basis of his general knowledge and according to the nature and the desired effect of said product.

Non-limiting examples of suitable consumer products include a perfume, such as a fine perfume, a splash or eau de parfum, a cologne or a shave or after-shave lotion or a cream or gel; a fabric care product, such as a liquid or solid detergent, a laundry powder, a fabric softener, a liquid or solid scent booster, a fabric refresher, an ironing water, a paper, a bleach, a carpet cleaner, a curtain-care product; a body-care product, such as a hair care product (e.g. a shampoo, a coloring preparation or a hair spray, a color-care product, a hair shaping product), a dental care product, a disinfectant, an intimate care product; a cosmetic preparation (e.g. a skin cream or lotion, a vanishing cream or a deodorant or antiperspirant (e.g. a spray or roll on), a hair remover, a tanning or sun or after sun product, a nail product, a skin cleansing, a makeup); or a skin-care product (e.g. a soap, a shower or bath mousse, oil or gel, or a hygiene product or a foot/hand care products); an air care product, such as an air freshener or a “ready to use” powdered air freshener which can be used in the home space (rooms, refrigerators, cupboards, shoes or car) and/or in a public space (halls, hotels, malls, etc.); or a home care product, such as a mold remover, a furnisher care product, a wipe, a dish detergent or a hard-surface (e.g. a floor, bath, sanitary or a window-cleaning) detergent; a leather care product; a car care product, such as a polish, a wax or a plastic cleaner; a candle; a spray, a coil, an electric diffuser, a piezo diffuser, a liquid electric diffuser, a diffusor, a rubber septum, a wristband, a patch, a collar, an ear tag, clothes, fabrics, papers, a biochar, a cardboard, cellulosic pads, bed nets, a screen, curtains, a varnish or a paint, more preferably a candle, a spray, a coil, an electric diffuser, a piezo diffuser, a liquid electric diffuser, a diffusor, a rubber septum, a wristband, a patch, a collar, an ear tag, clothes, fabrics, papers, a biochar, a cardboard, cellulosic pads, bed nets, a screen, curtains, a varnish or a paint.

In a preferred embodiment of the invention, the consumer product is an electric diffuser. In this embodiment of the invention, the substance in the arthropod, preferably insect, control composition is present at certain quantities.

Some of the above-mentioned consumer products may represent an aggressive medium for the members of the substances, so that it may be necessary to protect the latter from premature decomposition, for example by encapsulation or by chemically binding it to another chemical which is suitable to release the invention's ingredient upon a suitable external stimulus, such as an enzyme, light, heat or a change of pH.

The invention will be described in further detail by way of the following non-limiting examples.

### EXAMPLES

### 1. Description of the Arthropod Controlling Assays

The arthropod repellency is tested using small scale assays as described herein.

### Warm Body Assay for Insects Such as Mosquito:

Aedes aegypti is a model organism for controlling tests and one of the recommended model organisms by the World Health Organization (WHO) as it is a very aggressive anthropophilic mosquito species that shows generally low sensitivity to arthropod controlling compounds.

The controlling effect of the compositions according to the present invention was assessed using an adapted Warm Body assay as defined in Kröber T, Kessler S, Frei J, Bourquin M, Guerin PM. 2010. An in vitro assay for testing mosquito controlling compounds employing a warm body and carbon dioxide as a behavioral activator. J Am Mosq Control Assoc. 26:381-386. In this in-vitro assay the number of mosquito landing on a warm body, simulating an attractive host treated with the tested stimuli, was measured in order to assess the repellence effect.

The published protocol has been adapted in not manually counting the landing mosquitoes but using an automatic counting software, the switch from Anopheles gambiae to A. aegypti led to a decrease of mosquitoes' number placed in the tested cage due to the size difference (i.e. 30 mosquitoes instead of 50) and to an increase of lighting as A. aegypti is a diurnal mosquitoes (i.e. 150 lux instead of 4 lux).

As stated in Kröber et al. (2010), selected 10-12 days old hungry females, that had ad libitum access to 10% sugar solution but were not blood-fed, were selected for the assay. For each substance tested, at least three different concentrations were assessed ranging from 0.0016% up to 1% in ethanol for deterrence & repellence assessment.

On the sandblasted glass Petri dish covering the warm body (28.3 cm²), 100 μL of the compositions diluted at three to nine different concentrations in ethanol was applied. Control tests were carried by applying 100 μL of neat ethanol. The number of mosquito landing on the warm body was counted for each stimulus. The number of mosquito landing on neat ethanol was used to normalize the repellence of other stimuli, i.e. number of mosquitoes landing during control is equal to 0% repellence.

### 2. Evaluation of the Arthropod Controlling Effect of the Present Invention

### Preparation of Perfume Compositions of the Invention

The inventors prepared perfume compositions to be tested for arthropod repellency. The compositions of the perfumes are provided below. Each perfume was made to 100% using additional ingredients contribute to the hedonic profile of the individual perfume.

TABLE 1
Perfume A compositions

| | Perfumes | | | | | |
|---|---|---|---|---|---|---|
| IUPAC Name | A1 | A2 | A3 | A4 | A5 | A6 |
| Clove oil | 5% | 5% | 15% | 12% | 31% | 28% |
| 2-(4-methylcyclohex-3- | 7% | 7% | 19% | 16% | 15% | 24% |
| en-1-yl)propan-2-ol | | | | | | |
| Orange oil | 4% | 4% | 10% | 8% | 30% | 30% |
| 3,7-dimethylocta-2,6- | 3% | 3% | 8% | 7% | 10% | 7% |
| dien-1-ol | | | | | | |
| Mint oil | 15% | 15% | 43% | 35% | 10% | 8% |
| Thyme oil | 0.1% | 0.2% | 0.3% | 0.5% | 1% | 0.1% |

TABLE 2
Perfume B compositions

| | Perfumes | | | |
|---|---|---|---|---|
| IUPAC Name | B1 | B2 | B3 | B4 |
| 3,7-dimethylnona-1,6-dien-3-ol | 10% | 21% | 20% | 20% |
| 5-pentyloxolan-2-one | 5% | 10% | 10% | 10% |
| 3-methyl-5-phenyl-1-pentanol | 4% | 8% | 8% | 8% |
| Lavandin oil | 5% | 10% | 10% | 10% |
| Clove oil | 3% | 6% | 6% | 6% |
| 3,7-dimethylocta-2,6-dien-1-ol | 3% | 6% | 6% | 6% |
| Orange oil | 3% | 6% | 6% | 4% |
| chromen-2-one | 1% | 2% | 2% | 2% |
| 3,7-dimethylocta-2,6-dienal | 1% | 2% | 2% | 2% |
| 4-hydroxy-3-methoxybenzaldehyde | 1% | 2% | 2% | 2% |
| Cinnamon oil | 0.1% | 0.2% | 0.2% | 0.1% |

TABLE 3
Perfume C compositions

| | Perfumes | | | | |
|---|---|---|---|---|---|
| IUPAC Name | C1 | C2 | C3 | C4 | C5 |
| 5-pentyloxolan-2-one | 43% | 41% | 72% | 72% | 43% |
| 1,2,2-trimethyl-13-oxabicyclo[10.1.0]trideca-4,8-diene | 4% | 5% | 8% | 8% | 5% |
| 5-hexyloxolan-2-one | 4% | 4% | 7% | 8% | 4% |
| 6-pentyloxan-2-one | 2% | 2% | 4% | 4% | 2% |
| 5-butyloxolan-2-one | 2% | 2% | 4% | 4% | 2% |
| Lemongrass oil | 1% | 1% | 1% | 1% | 0.2% |
| Citronella oil | 0% | 0% | 0.25% | 0% | 0% |
| 3,7-dimethyloct-6-enal | 0% | 0.21% | 0.37% | 0.37% | 0% |
| 3,7-dimethylocta-2,6-dienal | 0% | 0% | 0% | 0.12% | 0% |

### Results of Warm Body Assay for Insects Such as Mosquito:

All six compositions managed to repel mosquitoes above 95% when applied at 1% on the attractive stimulus (Table 4). Already when applied at 0.04% on the attractive stimulus, composition A3 managed to reduce the number of mosquito landing by more than 60% (Table 4). Even better, at this same dose of 0.04%, compositions A5 and A6 managed to already have more than 90% of the mosquitoes repelled (Table 4).

TABLE 4
Repellent efficacy of six compositions against Aedes aegypti in a
Warm Body Assay. Each composition was tested at three different doses
applied on the attractive stimulus. The number of landings during each
control was used as a reference to normalize and calculate the percentage
of repellence at the three different doses. As an indication, an average ±
SD of 60 ± 12.3 mosquitoes landed on the unprotected attractive
stimulus during the 2 minutes control test periods.

| | 0.016 mg/mL | 0.4 mg/mL | 10 mg/mL |
|---|---|---|---|
| A1 | 38% | 49% | 98% |
| A2 | 13% | 41% | 97% |
| A3 | 39% | 61% | 100% |
| A4 | 0% | 36% | 98% |
| A5 | 15% | 95% | 100% |
| A6 | 41% | 91% | 100% |

All four compositions managed to repel mosquitoes above 95% when applied at 1% on the attractive stimulus (Table 5). Already when applied at 0.04% on the attractive stimulus, composition B2 managed to reduce the number of mosquito landing by more than 50% (Table 5).

TABLE 5
Repellent efficacy of four compositions against Aedes aegypti
in a Warm Body Assay. Each composition was tested at three
different doses applied on the attractive stimulus. The number
of landings during each control was used as a reference to
normalize and calculate the percentage of repellence at the
three different doses. As an indication, an average ±
SD of 52 ± 9.2 mosquitoes landed on the unprotected attractive
stimulus during the 2 minutes control test periods.

| | 0.016 mg/mL | 0.4 mg/mL | 10 mg/mL |
|---|---|---|---|
| B1 | 20% | 25% | 97% |
| B2 | 10% | 58% | 100% |
| B3 | 0% | 27% | 100% |
| B4 | 47% | 46% | 98% |

All five compositions managed to repel mosquitoes above 95% when applied at 1% on the attractive stimulus (Table 6). Already when applied at 0.04% on the attractive stimulus, composition C3 managed to reduce the number of mosquito landing by 60% (Table 6). Even better, at this same dose of 0.04%, compositions C1, C2, C4 and C5 managed to already have more than 80% of the mosquitoes already repelled, reaching no landings at all with composition C4 (Table 6).

TABLE 6
Repellent efficacy of five compositions against Aedes aegypti
in a Warm Body Assay. Each composition was tested at three
different doses applied on the attractive stimulus. The number
of landings during each control was used as a reference to
normalize and calculate the percentage of repellence at the
three different doses. As an indication, an average ±
SD of 66 ± 8.5 mosquitoes landed on the unprotected attractive
stimulus during the 2 minutes control test periods.

| | 0.016 mg/mL | 0.4 mg/mL | 10 mg/mL |
|---|---|---|---|
| C1 | 27% | 80% | 97% |
| C2 | 36% | 84% | 97% |
| C3 | 7% | 60% | 98% |
| C4 | 0% | 100% | 100% |
| C5 | 11% | 85% | 97% |

All five compositions managed to repel mosquitoes above 95% when applied at 1% on the attractive stimulus (Table 7). The level of repellence above 90% already started at a concentration of 0.2% with composition C2 and at 0.089% with composition B4 (Table 7). Even better, no mosquito landed on the attractive stimuli as soon as it was baited with more than 0.04% of composition C4 (Table 7).

TABLE 7
Repellent efficacy of five compositions against Aedes aegypti in a Warm Body
Assay. Each composition was tested at nine different doses applied on the attractive
stimulus. The number of landings during each control was used as a reference
to normalize and calculate the percentage of repellence at all the different
doses. As an indication, an average ± SD of 59 ± 3.6 mosquitoes landed
on the unprotected attractive stimulus during the 2 minutes control test periods.

| | concentrations [mg/mL] | | | | | | | | |
|---|---|---|---|---|---|---|---|---|---|
| | 0.0032 | 0.016 | 0.0357 | 0.08 | 0.178 | 0.4 | 0.89 | 2 | 10 |
| A1 | 0% | 38% | 30% | 21% | 11% | 49% | 11% | 11% | 98% |
| B1 | 0% | 20% | 0% | 27% | 8% | 25% | 60% | 86% | 97% |
| B4 | 16% | 47% | 13% | 13% | 42% | 46% | 93% | 97% | 98% |
| C2 | 23% | 36% | 0% | 0% | 0% | 84% | 60% | 95% | 97% |
| C4 | 0% | 0% | 42% | 85% | 47% | 100% | 100% | 100% | 100% |

1. An arthropod control composition comprising one or more of the following combinations of substances:
(a) clove oil, 2-(4-methylcyclohex-3-en-1-yl)propan-2-ol, orange oil, 3,7-dimethylocta-2,6-dien-1-ol and mint oil;
(b) 3,7-dimethylnona-1,6-dien-3-ol, 5-pentyloxolan-2-one, 3-methyl-5-phenyl-1-pentanol, lavandin oil, clove oil, 3,7-dimethylocta-2,6-dien-1-ol and orange oil; or
(c) 5-pentyloxolan-2-one, 1,2,2-trimethyl-13-oxabicyclo[10.1.0]trideca-4,8-diene and 5-hexyloxolan-2-one.

2. The arthropod control composition of claim 1, wherein combination (a) comprises: 5-40% clove oil, 5-35% 2-(4-methylcyclohex-3-en-1-yl)propan-2-ol, 4-40% orange oil, 2-20% 3,7-dimethylocta-2,6-dien-1-ol, and 2-70% mint oil.

3. The arthropod control composition of claim 1, wherein combination (a) further comprises 0.01 to 20% thyme oil.

4. The arthropod control composition of claim 1, wherein combination (b) comprises: 5-35% 3,7-dimethylnona-1,6-dien-3-ol, 2-20% 5-pentyloxolan-2-one, 2-20% 3-methyl-5-phenyl-1-pentanol, 2-20% lavandin oil, 1-20% clove oil, 1-15% 3,7-dimethylocta-2,6-dien-1-ol and 1-15% orange oil.

5. The arthropod control composition of claim 4, wherein combination (b) further comprises 0.5-10% chromen-2-one, 0.5-10% 3,7-dimethylocta-2,6-diena, 0.5-10% 4-hydroxy-3-methoxybenzaldehyde and 0.01-10% cinnamon oil.

6. The arthropod control composition of claim 1, wherein combination (c) comprises: 20-90% 5-pentyloxolan-2-one, 2-15% 1,2,2-trimethyl-13-oxabicyclo[10.1.0]trideca-4,8-diene, 2-15% 5-hexyloxolan-2-one.

7. The arthropod control composition of claim 6, wherein combination (c) further comprises 0.5-10% 5-hexyloxolan-2-one, 0.5-10% 6-pentyloxan-2-one, 0.01-10% 5-butyloxolan-2-one, 0.01-10% lemongrass oil, 0.01-10% citronella oil, 0.01-5% 3,7-dimethyloct-6-enal, 0.01-5% 3,7-dimethylocta-2,6-dienal.

8. The arthropod control composition according to claim 1, wherein the arthropod is a mosquito.

9. The arthropod control composition according to claim 1, further comprising an arthropod control co-ingredient being selected from the group consisting of: N,N-diethyl-3-methylbenzamide, ethyl butylacetylaminopropionate; para-menthan-3,8-diol; 1-(1-methylpropoxycarbonyl)-2-(2-hydroxaethyl)piperidin; Cedarwood oil China, Cedarwood oil Texas, Cedarwood oil Virginia, Cinnamon oil, Citronella oil, Cornmint oil, Cymbopogon winterianus oil fractionated hydrated cyclized, decanoic acid, Eucalyptus citriodora oil Eucalyptus citriodora oil hydrated cyclized, eugenol, Garlic oil, geraniol, Geranium oil, Lavender, Lavandula hybrida ext., Lavandin oil, Lemon oil, Lemongrass oil, Margosa extract, Metofluthrin, mixture of cis- and trans-p-menthane-3,8 diol, N,N-diethyl-meta-toluamide, nonanoic acid, Rosemary oil, Thyme oil, Wintergreen oil, 2,3,4,5-bis(butyl-2-ene)tetrahydrofurfural, cineole, cinnamaldehyde, citronellal, citronellol, coumarin, dibutyl phthalate, diethyl phthalate, dimethyl anthranilate, dimethyl phthalate, ethyl vanillin, Eucalyptus oil, delta-octalactone, delta-nonalactone, delta-decalactone, delta-undecalactone, delta-dodecalactone, gamma-octalactone, gamma-nonalactone, gamma-decalactone, gamma-undecalactone, gamma-dodecalactone, hydroxy citronellal, Lime oil, limonene, linalool, methyl anthranilate, Mint oil, myrcene, Neem oil, sabinene, β-caryophyllene, (1H-indol-2-yl)acetic acid, anethole, Anise oil, Basil oil, Bay oil, camphor, ethyl salicylate, Evergreen oils, (1,3,4,5,6,7-hexahydro-1,3-dioxo-2H-isoindol-2-yl)methyl (1R-trans)-2,2-dimethyl-3-(2-methylprop-1-enyl)cyclopropanecarboxylate (d-Tetramethrin), (RS)-3-Allyl-2-methyl-4-oxocyclopent-2-enyl-(1R,3R; 1R,3S)-2,2-dimethyl-3-(2-methylprop-1-enyl)-cyclopropanecarboxy late (mixture of 4 isomers 1R trans, 1R:1R trans, 1S: 1R cis, 1R: 1R cis,1S 4:4:1:1), (RS)-α-cyano-3phenoxybenzyl-(1RS)-cis, trans-3-(2,2-dichlorovinyl)-2,2-dimethylcyclopropanecarboxylate, 2-methyl-4-oxo-3-(prop-2-ynyl)cyclopent-2-en-1-yl 2,2-dimethyl-3-(2-methylprop-1-enyl)cyclopropanecarboxylate, Acetamiprid, Azadirachtin, Bendiocarb, Bifenthrin, boric acid, Chlorpyrifos, Deltamethrin, Diazinon, Dichlorvos, eugenol, Fipronil, Imidacloprid, linalool, Malathion, Maltodextrin, Metofluthrin, Nicotine, Permethrin, Pyrethrins and Pyrethroids, Rotenone, silicium dioxide, S-Methoprene, Spinosad, Spinosyn D, Tetramethrin, Transfluthrin, (E)-1-(2,6,6-trimethylcyclohex-2-en-1-yl)but-2-en-1-one, (3Z)-3-butylidene-2-benzofuran-1-one, 4-ethenyl-2-methoxyphenol, Cognac oil green, Labdanum extract, 5-pentyloxolan-2-one, chromen-2-one, (2E)-3,7-dimethylocta-2,6-dienal, 4-hydroxy-3-methoxybenzaldehyde, (5R)-2-methyl-5-prop-1-en-2-ylcyclohex-2-en-1-one, Mentha spicata oil, 6-hexyloxan-2-one, 5-methyl-2-propan-2-ylcyclohexyl] acetate, Nigella damascena oil, 2-phenylethanol, 6-pentyloxan-2-one, (4-methoxyphenyl)methyl acetate, Syzygium aromaticum oil, 3,4,4a,5,6,7,8,8a-octahydrochromen-2-one, (1S,6R)-3,7,7-trimethylbicyclo[4.1.0]hept-3-ene, 2-phenylethyl 2-methylpropanoate, methyl 2-(3-oxo-2-pent-2-enylcyclopentyl)acetate, (4R)-4-(2-methoxypropan-2-yl)-1-methylcyclohexene, Mentha piperita oil, 2-methoxy-4-[(E)-prop-1-enyl]phenol, 2-methyl-3-(4-propan-2-ylphenyl)propanal and (4-methoxyphenyl)methanol and mixtures thereof.

10. A method for arthropod control which comprises bringing an insect into direct contact or in contact with vapors of an arthropod control composition according to claim 1.

11. (canceled)

12. An arthropod control article comprising the arthropod control composition according to claim 1.

13. The arthropod control article according to claim 12, wherein the article is a consumer product.

14. The arthropod control article according to claim 12, wherein the article is a fabric care product; a body-care product; a skin-care product; an air care product; or a home care product; a leather care product; a car care product; a candle; a spray; a coil, an electric diffuser, a piezo diffuser, a liquid electric diffuser, a diffusor, a rubber septum, a wristband, a patch, a collar, an ear tag, clothes, fabrics, papers, a biochar, a cardboard, cellulosic pads, bed nets, a screen, curtains, a varnish, or a paint.

15. The arthropod control article according to claim 14, wherein the article is an electric diffuser.
